(19) United States
(12) Patent Application Publication
(10) Pub. No.: US 2022/0232802 A1
(43) Pub. Date: Jul. 28, 2022

(54) SCENTED PET CHEW

(71) Applicant: John J. Stone, Golden, CO (US)

(72) Inventor: John J. Stone, Golden, CO (US)

(21) Appl. No.: 17/159,014

(22) Filed: Jan. 26, 2021

(51) Int. Cl. A01K 15/02

(52) U.S. Cl. CPC A01K 15/026

(57) ABSTRACT

The invention comprises a novel pet chew toy where the outer shell is molded over a scented inner section and has varying hardness to the shell and inner section so that the sensation resembles chewing an actual bone, but without the health hazards possible with actual bones. There is no glue or other harmful materials used to keep the 2 sections together, yet they will not come apart due to the molding process.

### FIELD

The invention relates to a novel pet puzzle toy and food dispenser in which treats are located in receptacles wherein retrieval requires the pet to both spin and rock the puzzle in order to obtain the food.

### BACKGROUND OF THE INVENTION

The invention most closely corresponds with USPTO Class 119/702 wherein (lass 119 relates to animal husbandry and sub-class 702 includes exercise or amusement devices for animals.

In its simplest form, the invention comprises a novel pet chew wherein a scented soft TPE center section is encased by a harder TPE outer section with molded end overlays so a pet can chew the toy without having to ingest the scented center, and wherein the center will not be removed from the casing.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus, it is key to provide the pet with interesting toys to chew.

### THE INVENTION

### Summary, Objects and Advantages

In the known art, a major issue arises when chew toys come apart and can cause a choking hazard. If a pet owner is not home the pet can suffer serious injuries or even death from choking on pieces of a chew toy.

With the inventive chew toy, the outer casing is molded so that the softer inner section cannot conic loose or be removed by the pet, yet it will provide an experience similar to a real bone. The varying hardness of the outer casing and the inner casing aids in that sensation.

During the molding process the outer casing ends are formed with an edge lip around the circumference of the openings. The inner scented section rests flush within the outer casing so that the pet can smell the scent, but even during aggressive chewing, the inner section cannot come out of the outer casing due to the lip edges which hold the inner section in.

There is no glue or any other potentially harmful material used to affix the two sections of the chew toy together.

### BRIEF DESCRIPTION OF THE DRAWINGS

The invention is described in further detail by reference to two (2) drawings sufficient in detail to describe the invention in which:

FIG. 1 is a view of the chew with the inner casing inserted into the outer casing; and

FIG. 2 is an exploded view of the two casings individually.

### DETAILED DESCRIPTION, INCLUDING BEST MODES OF CARRYING OUT THE INVENTION

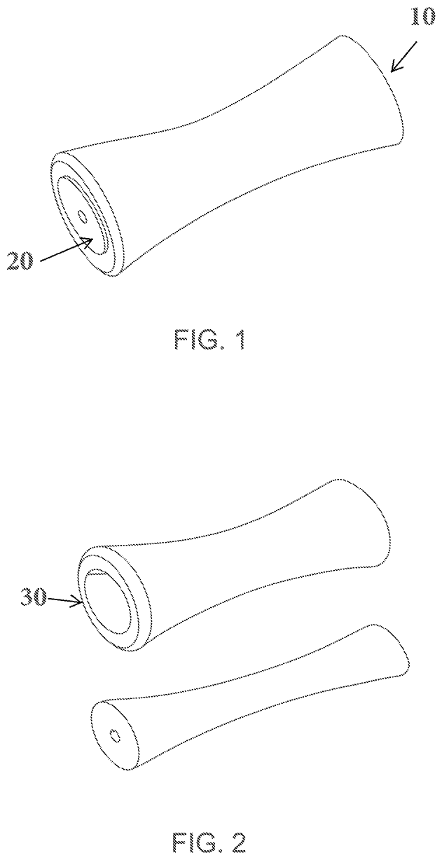

FIG. 1 illustrates the chew toy with the outer casing 10 and the softer inner casing 20 as ready for pet use. The outer casing is made with TPE, specifically T-Flex Ultra. TPE is a true thermoplastic, which does not require vulcanization or curing. Thermoplastic elastomers are processed using a variety of plastic manufacturing equipment such as, injection molding, extrusion, and blow molding. A TPE can be utilized in advanced processing such as, over molding and two-shot molding, and can also undergo secondary operations such as, welding and bonding to various materials. Thermoplastic elastomers offer part design flexibility and easy bonding to other thermoplastic substrates. The bonding to the inner section is accomplished without potentially harmful glues or other affixations.

FIG. 2 is an exploded view of both the outer casing 10 and inner casing 20 separate to purposes of illustrating shape, size and fit. FIG. 2 also shows the molded lip 30 of the outer casing which holds the scented inner section within. No glue or other fixatives are used. The inner core is made with TPEV which is a compound of PP and EPDM rubber that have been dynamically vulcanized during the compounding step. The inner section optimally uses TPEV for its durability, flexibility and wide range of hardness. Given the flexibility of the outer section being slightly more than the inner section, the sensation in response to the pet chewing resembles that of an actual bone with marrow in the center. Such real bones are modernly not advised by veterinarians due to splintering and choking hazard. The inventive chew bone is an optimal replacement.

1) A scented chewable pet bone with;
a) a non-removable outer shell made of TPE with openings at each end
b) openings having a lip around the circumference of the openings that turn inward
c) an inner section made of TPEV
d) an inner section scented with bacon

2) A scented chewable pet bone as in claim 1 wherein the outer shell is made of molded TPE and is opaque and wherein the mold includes a lip around each end opening to impede the center section from being dislodged therefrom.

3) A scented chewable pet bone as in claim 1 wherein the inner section is made of TPEV and is designed to tit flush within the outer shell and held therein by the lips around the end openings of the outer shell.

4) A scented chewable pet bone as in claim 1 wherein no fixation methods are used to retain the inner section except the outer shell lip around the end openings.

5) A scented chewable pet bone as in claim 1 wherein the inner section is scented with a natural bacon flavor.
